(19) United States
(12) Patent Application Publication
(10) Pub. No.: US 2004/0135973 A1
(43) Pub. Date: Jul. 15, 2004

(54) Display device with multiple focal planes

(76) Inventors: Torbjorn Gustafsson, Linkoping (SE); Stan Zyra, Linkoping (SE)

Correspondence Address: Jacobson Price, Holman & Stern, Professional Limited Liability Company, 400 Seventh Street NW, Washington, DC, 20004, US

(21) Appl. No.: 10/476,491

(22) PCT Filed: May 8, 2002
(86) PCT No.: PCT/SE02/00893

(30) Foreign Application Priority Data
May 10, 2001 (SE) 0101633-6

(51) Int. Cl. G03B 21/00

(52) U.S. Cl. 353/10

(57) ABSTRACT

The present invention relates to a display device with variable focusing depth. The display device presents from electrical signals an image built up of at least two sub-images for the eye (7) of an observer. Focusing depth is generated in the image by different sub-images being generated with different focal distances and that objects in the image are distributed in the sub-images with regard to the depth effect one intends to create in the image.

The present invention relates to a display device with multiple focal planes.

Various types of problems can be solved in a cost-efficient way with the help of simulators. The use of simulators is growing and can be expected to increase even more in the future. In simulators of the type “virtual reality”, VR, the user often wears a device on the head resembling a helmet or eyeglasses, which cover the eyes and in some cases the ears. The user can also have a number of sensors on different parts of the body which sense movements and location. With the support of information from the sensors for instance, the computer creates the illusion of an artificial three-dimensional world in the form of images which are projected to the eyes with the help of some form of display device, e.g. screens. A purpose of virtual reality is to create realistic simulators.

Display devices normally used today have the disadvantage of not resembling reality sufficiently well. This deficiency in realism can cause the observer irritation and discomfort, as the behavior that the observer acquires by experience cannot be used to a full extent in a natural manner.

One example of a deficiency of the above-mentioned type is that all image information is presented on one single focal plane in the normally used display devices of today. This results in the observed image having the same focus regardless of where the object is placed in the direction of depth.

The brain receives information of depth from for instance the composition of the images gathered for each eye and from the focusing of the eye lens. If the information of depth from the images does not agree with the focusing depth, then this often leads to discomfort and can obscure the sense of reality.

In many cases it is sufficient to be able to present images containing objects placed in two focal planes. In an automobile- or aircraft-simulator it is often sufficient to be able to place objects partially at infinity, that is further away than 10 m, and partially at a distance of 50-70 cm, which regards the distance between the eye of the driver and the instrument panel. Trials have been made previously with the aim of having a user experience depth effect of the type accommodation. The user has then been supplied with a gaze tracker, a screen, a variable lens and a computer. With the help of information from the gaze tracker, the computer can determine which object the user is looking at. The lens then adjusts so that the regarded object is put into the correct focal depth in relation to the user. A disadvantage with such a system is that all objects, even those which are not being looked at and which belong to another focal plane, momentarily fall on one and the same focal plane. Another disadvantage is that a gaze tracker cannot in some cases determine with sufficient precision which object the user is momentarily looking at.

The present invention gives a solution to the problem of placing virtual objects in at least two different focal planes in one and the same image, in that the invention is given the features that appear from the following independent claim. Suitable embodiments of the invention will be evident from the remaining claims.

The invention will be described in detail in the following with reference to the enclosed drawings, where

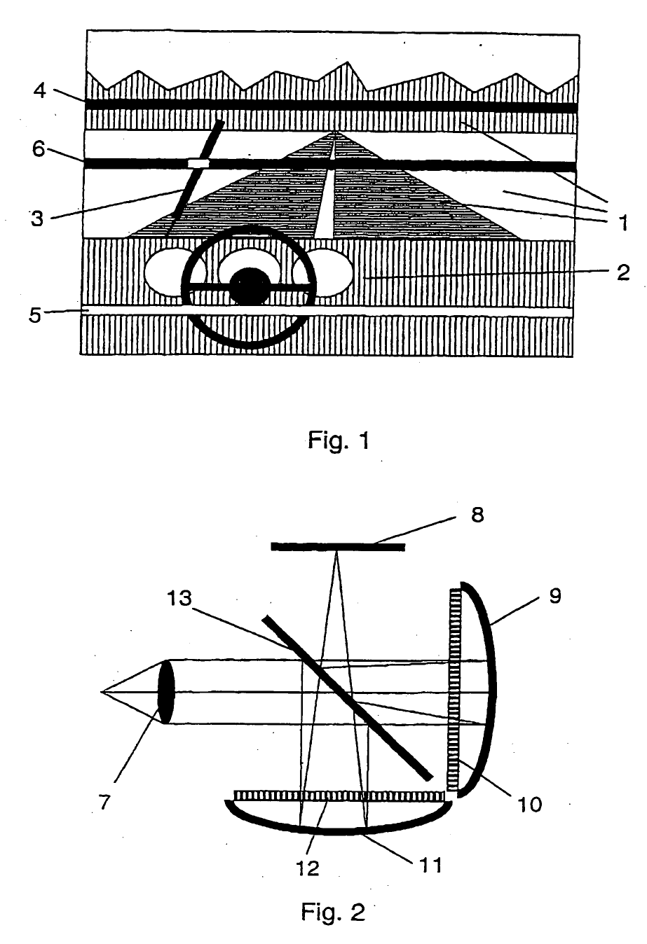

FIG. 1 shows an example of an automobile simulator according to the invention,

FIG. 2 shows a fist embodiment of the invention which utilises polarisation effects,

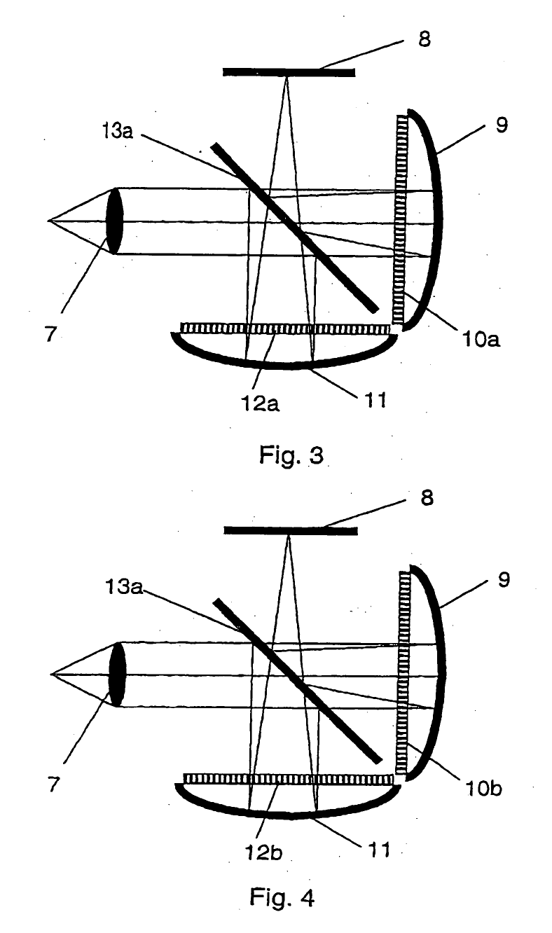

FIG. 3 shows a second embodiment of the invention which utilises controllable radiation-blocking devices,

FIG. 4 shows a third embodiment of the invention which utilises two wavelength-intervals and bandstop filters,

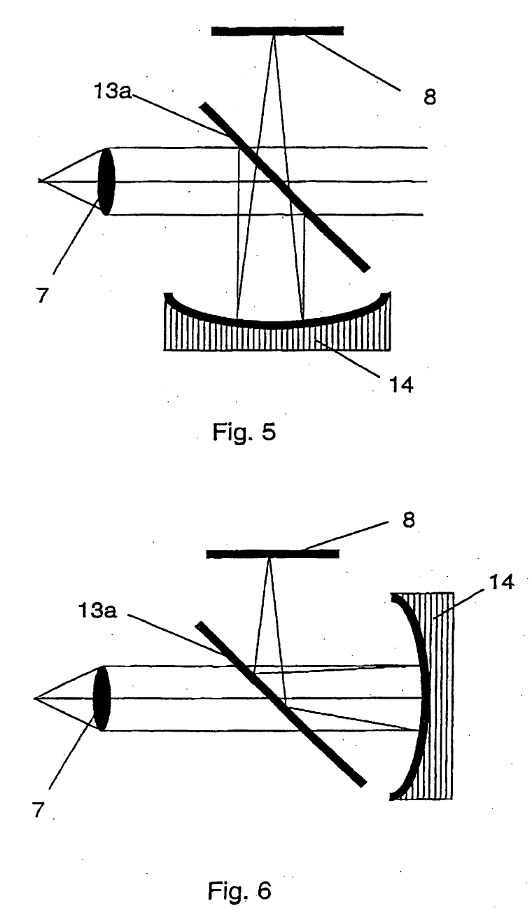

FIG. 5 shows a fourth embodiment of the invention which utilises an adaptive mirror and is transparent,

FIG. 6 shows a fifth embodiment of the invention which utilises an adaptive mirror and is not transparent,

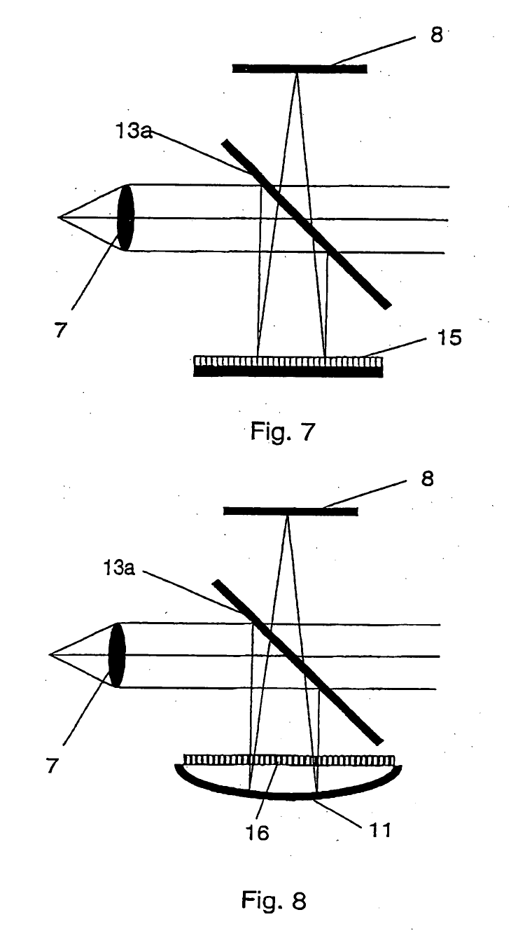

FIG. 7 shows a sixth embodiment of the invention which utilises a reflecting spatial light modulator,

FIG. 8 shows a seventh embodiment of the invention which utilises a transparent spatial light modulator in combination with a spherical mirror and

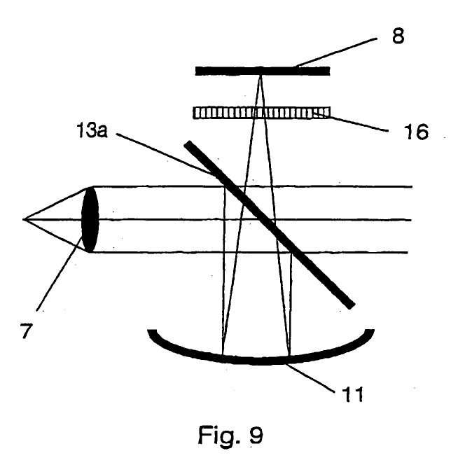

FIG. 9 shows an eighth embodiment of the invention which is a variant of the seventh embodiment and which also utilises a transparent spatial light modulator in combination with a spherical mirror.

Fundamental to the invention is as mentioned that the pixels in a presented image are generated so that they are perceived by an observing eye on at least two different focal distances. The display device presents the images as a result of electrical signals to the display device. The images can be created in a computer, as in presentation of a virtual reality in games and other contexts. The images can however also be ordinary video images from a video film or other storage medium which is combined with the stored information from a range-finding unit, e.g. a laser radar over the corresponding area to give the distance in each pixel in the video image, When one shall determine on which of the at least two focal planes the pixels are to be placed, this can be done through a simple subdivision into distance bins.

In the terminology used in this patent application, an image means that which the observer comprehends as an image. This is then built up of sub-images, which are parts of the mentioned image. Sub-images can be embodied by superficially-connected parts of the image, however see further explanations below.

In some of the applications of the following an image source in the form of a Virtual Retinal Display (VRD) is used. VRD is a technique where an intensity-modulated laser beam or beam from another intensity-modulated light source, e.g. a light diode, is deflected in the horizontal and vertical directions. The light beam draws up in this way an image on the retina of the user. In the terminology used in this patent application, this gives the extreme case where each pixel can be seen as a sub-image. Other types of image sources illuminate the eye simultaneously with image information from all or a large number of pixels.

A method for generating the different focal planes is to divide the radiation into different beams of radiation. The radiation which shall illuminate the pixels that are to lie upon a certain focal plane may then go a certain path and radiation which shall illuminate other pixels is led another path. Different ways can be considered for separating light which one wishes to go along different paths in this manner.

Method A:

The image source can be a VRD. As the image information from only some single pixel hits the eye at every instant, objects which consist of one or several pixels can be placed on different focal planes if the path of radiation for the light beam can be changed at a velocity which in magnitude corresponds to a few pixels.

In FIG. 1 an example of an automobile simulator is shown. On a display device, an image is shown representing a road through terrain 1 as well as the instrument panel 2 of the automobile and windshield wiper 3. In the VRD-case the image is built up by a light beam for example being deflected in succession from left to right and from above and downwards. The light beam shown above is made to go in a radiation path 4 (marked in black), which corresponds to a focal plane at a far distance. The light beam shown below is made to go in another radiation path 5 (marked in white), which corresponds to a focal plane at a close distance. In the intermediate case 6 the radiation path is changed during the horizontal deflection of the light beam as it passes the windshield wiper, which lies on a focal plane other than the surroundings.

Method A1:

FIG. 2 shows a device that has a display 8 as image source. The display device can for example be of VRD-type. Under all circumstances the display device emits at every instance only radiation, which shall go along one and the same optical path. The radiation reaches a polarising beam splitter 13. Such a beam splitter can comprise a polarising layer, i.e. a layer with the property of reflecting a certain type of polarised radiation, for example V-polarised radiation, and transmitting another type of polarised radiation, for example H-polarised radiston. The beam splitter can even be a prism of one of the types Wollaston, Thompson or Glan. After the beam splitter, the radiation in both of the optical paths passes a polarisation-rotating plate 10 and 12 respectively before and after reflection in the reflecting devices 9 and 11 respectively. The reflecting devices can be spherical mirrors. In a special embodiment the device 9 can be a spherical partially-reflecting mirror with the object of imparting transparency to the device. The lens of the observing eye is called 7.

The polarisation-rotating plates 10 and 12 respectively rotate the polarisation direction of the radiation by 45° for each passage depending on whether voltage is placed on the beam splitter 13 or not, and the opposite with inverse control signals on the beam splitter. The polarisation-rotating plates are of so-called “non-reciprocal typed”, which results in the polarisation-rotating being in total 90° on passage forwards and backwards through each respective plate. In the figure the light will return the same way it came if the plates 10 or 12 are not activated. If the plate 12 is activated then the light that passed the beam splitter 13 will be reflected by this after reflection in the mirror 11. If the plate 10 is activated then the light that was reflected in the beam splitter 13 will pass this after reflection in the mirror 9.

Method A2:

Instead of working with polarising surfaces for mirroring and transmission, radiation-blocking devices 10a and 12a respectively can be used. FIG. 3 shows again a display 8 as image source, for example a VRD. After passage of an arbitrary beam splitter 13a, the radiation must pass a radiation-blocking device 10a or 12a respectively, the transmission of which can be controlled electrically. The radiation-blocking device can be of the same type that is used in displays of the type LCD and consists of a layer of liquid crystal with associated polarisation filter. Such radiation-blocking devices have a voltage-controlled light-transparency.

Other components can be the same as in FIG. 2, where for example the mirror 9 can be totally reflecting or partially reflecting.

Method B:

Another method of embodying the display device utilises a wavelength difference to divide radiation that is to follow different optical paths.

In the case where one wishes to present an entire scene for the observer, one can suitably use two narrow wavelength intervals that are so closely situated that they are comprehended by the observing eye as essentially the same wavelength. In another case one can use two separate wavelength intervals and use the distinct wavelength difference to clarify for example a symbol presentation.

In this case the radiation is led to an arbitrary beam splitter 13a that divides up the radiation into two parts. Each part is then led to a reflecting device 9 or 11 respectively which reflects the radiation back to the beam splitter and adapts the extension of each respective part when it falls onto the beam splitter so that together from the beam splitter they make up a complete reproduction of the image source. This image is then led to the eye of the observer.

Method B1:

In a first embodiment of this type of device shown in FIG. 4. the image source 8 is comprised of a display, for example a VRD. Each beam of radiation from the beam splitter may pass a bandstop filter 10b or 12b respectively. One filter blocks the radiation of one of the wavelengths in question, or the wavelength interval, and the other filter blocks the radiation of the other wavelength in question, or the wave length interval. In this way each pixel of the presented image is illuminated only by radiation of one wavelength.

Other components can be the same as in FIG. 2, by which for example the mirror 9 can be totally reflecting or partially reflecting.

Method B2:

One can also in a device with radiation of at least two wavelengths, or wavelength intervals, use other types of image sources than VRD. It is thus possible to use a display based on ferro-electrical liquid crystals, FLC as image source. In this type of display a matrix of pixels is illuminated. Behind the matrix plane is a mirror which reflects radiation when the pixel lying in front is transparent. Other components can be the same as in FIG. 4.

Method B3:

It is also possible to use a display 9 based on liquid crystals, LCD as image source. In this type of display a matrix of pixels is illuminated from behind. The pixels can be transparent or opaque depending on the pixel information. Radiation passes when the matrix is transparent. Other components can be the same as in FIG. 4.

The technique can of course be used in a colour system. Then normally 6 different light sources are required. In a system with red, green and blue colours, two red light sources are required, one for near-lying objects and one for distant objects, as well as likewise two green and two blue light sources. Of course three other suitably adapted colours can also be used.

Instead of dividing up the beam of radiation into separate sub-beams of radiation one can individually control the focal plane of each pixel in different ways.

Method C,

It is possible to generate different focal planes in one and the same image with the help of an electrically-controlled mirror. A mirror of this type can quickly change. focal length as a function of applied control voltage. Such a mirror is a so-called “micro-machined” adaptive mirror 14. The placement of the mirror in a display system is evident in FIGS. 5 and 6, where FIG. 5 shows a device with transparency and FIG. 6 shows one without transparency. Other components have the same designations as in other figures.

An image can be comprised of a number of sub-images which for example are shown to the eye in a sequential succession. By changing the focal length of the mirror before each new sub-image, the image object can be placed on different focal planes. Also here one can work with sub-images of different colour, usually a red, a green and a blue one.

Method D:

One can also use a spatial light modulator SLM, to control the focal plane of each pixel individually. An SLM consists of a matrix of optical elements which can be programmed to have different optical properties. An SLM can for example be of the type micromirror-SLM or LC-SLM (Liquid Crystal). Certain SLM:s are reflecting through combination with a mirror surface while others are transparent.

An SLM of the first type can for example be programmed to resemble a spherical mirror. An SLM can be quickly re-programmed, which explains why the function of a e.g. spherical mirror with variable focal length can be resembled. In FIG. 7 an SLM of the first type 15 is shown placed in a display device. If one is not interested in transparency, the SLM can instead as an alternative be placed in the radiation path right in front of the observing eye 7.

An SLM with transparency 16 can be combined with a spherical or planar mirror 11 and thus the function of a spherical mirror with variable focal length can be resembled. FIGS. 8 and 9 show what such a combination can look like and how it can be placed in a display device. If one is not interested in transparency, the mirror can instead as an alternative be placed in the radiation path right in front of the observing eye 7.

1. Display device which from electrical signals presents for the eye (7) of an observer an image made up of at least two sub-images, each comprising pixels, characterised in that the display device generates focusing depth in the image by generating different sub-images with different focal distances and that objects in the image in the form of a number of pixels are distributed in sub-images with regard to the depth effect one intends to create in the image.

2. Display device according to claim 1, characterised in that pixels at a certain focal distance are generated by a beam of radiation which has been led along a certain optical path between the image source (8) and respective pixel and pixels at some other certain focal distance are generated by a beam of radiation which has been led along another optical path between the image source and respective pixel, that the radiation is divided up into different beams of radiation with the help of a beam splitter (13, 13a), that each beam of radiation is led to a reflecting device (9, 11) which reflects radiation back to the beam splatter and adapts the extension of each respective part when it falls onto the beam spitter 80 that they are compiled by the beam splitter into a complete image.

3. Display device according to claim 2, characterised in that one reflecting device (9, 11) is a totally reflecting mirror and the other a partially reflecting device, with the purpose of giving transparency to the display device.

4. Display device according to claim 2 or 3, characterised in that the image source (8) at every instant only emits radiation which shall go along one and the same optical path, that the beam splitter is a polarising beam splitter (13), that a polarisation-rotating device (10, 12) is placed in the path of each beam of radiation and that one utilises the polarisation to ensure that from each optical path the pixels reaching an observing eye are only those which are intended to lie at the focal distance to which the optical path gives rise.

5. Display device according to claim 2 or 3, characterised in that the image source (8) at each instant only emits radiation which shall go along one and the same optical path, that controllable radiation-blocking devices (10a, 12a) are placed in the path of each beam of radiation, by which the radiation-blocking devices are arranged to be controlled so that from each optical path the pixels reaching an observing eye are only those which are intended to lie at the focal distance to which the optical path gives rise.

6. Display device according to claim 5, characterised in that the controllable radiation-blocking devices (10a, 12a) comprise a layer of liquid crystal and associated polarisation filter with a voltage-controlled light transparency.

7. Display device according to claim 2 or 3, characterised in that the pixels radiate within one of at least two different wavelength intervals and that the display device comprises a device (10b, 12b) which utilises the wavelength difference to separate the radiation which shall go along different optical paths.

8. Display device according to claim 7, characterised in that the wavelength intervals are so near-lying wavelength-wise that they are comprehended by the observing eye (7) as the same wavelength interval.

9. Display device according to claim 7, characterised in that the wavelength intervals are so distant wavelength-wise that they are comprehended by an observing eye as different wavelengths, which is used to mark a difference, as in marking symbols in a pictorial environment.

10. Display device according to claim 1, characterised in that the image source (8) at each instant only emits radiation which shall go along one and the same optical path and that an adaptive spherical mirror (14) is included in the radiation path, which is controlled so that it at each instant gives the focal distance at which the then emitted pixels are to be presented.

11. Display device according to claim 1, characterised in that a spatial light modulator (15, 16) is included in the radiation path, which light modulator is controlled such that each pixel is presented at the intended focal distance.

12. Display device according to anyone of the previous claims, characterised in that the image source is comprised of a so-called Virtual Retinal Display.

13. Display device according to anyone of the previous claims, characterised in that the image source is comprised of an illuminated matrix of liquid crystal.
